(19) United States
(12) Patent Application Publication
(10) Pub. No.: US 2026/0055218 A1
(43) Pub. Date: Feb. 26, 2026

(54) POLYETHYLENES AND ARTICLES THEREOF

(71) Applicant: ExxonMobil Chemical Patents Inc., Spring, TX (US)

(72) Inventor: Rhutesh K. SHAH, Katy, TX (US)

(21) Appl. No.: 19/106,071

(22) PCT Filed: Aug. 7, 2023
(86) PCT No.: PCT/US2023/071776

§ 371 Date: Feb. 24, 2025

Related U.S. Application Data
(60) Provisional application No. 63/374,856, filed on Sep. 7, 2022.

(51) Int. Cl. C08F 210/16; B65D 35/02; B65D 65/40; C08J 5/18

(52) U.S. Cl. CPC C08F 210/16; B65D 35/02; B65D 65/40; C08J 5/18; C08F 2800/20; C08J 2323/08

(57) ABSTRACT

The present disclosure generally relates to polyethylene polymers and to articles made therefrom. In some embodiments, a polyethylene copolymer includes ethylene units, and 1 wt % to 8 wt % of C₃-C₈ alpha-olefin comonomer units. The polyethylene copolymer has a density of 0.934 g/cm³ to 0.945 g/cm³, a melt index (MI, determined per ASTM D1238 at 190° C. and 2.16 kg loading) greater than 1 g/10 min and less than or equal to 2.5 g/10 min, a composition distribution breadth index of 75% or greater, a molecular weight distribution (MWD, M_{w}/Mₙ) of 2 to 8, and a melt index ratio (MIR) within the range from 30 to 75, wherein MIR is the ratio of high load melt index (HLMI, ASTM DI 238 at 190° C., 21.6 kg) to melt index (MI, ASTM DI 238 at 190° C., 2.16 kg).

### CROSS-REFERENCE TO RELATED APPLICATION

This application claims the benefit of U.S. Provisional Application 63/374,856 filed Sep. 7, 2022, entitled “Polyethylenes and Articles Thereof”, the entirety of which is incorporated by reference herein.

### FIELD

The present disclosure generally relates to polyethylene polymers and to articles made therefrom.

### BACKGROUND

Medium density polyethylene polymers (or resins) are used in applications such as lamitubes, blown breathable films, waterproof sheets, and pipe adhesives. For achieving high throughput rates during processing, it is desirable for the polymers to have low melt rates at those shear rates typically encountered during extrusion and melt processing. Polymers with high melt indices (lower molecular weight) can often demonstrate the desired low melt viscosities in the extrusion shear rate regime. However, such high melt index polymers also exhibit low melt viscosities at lower shear rates (such as at zero shear viscosity) which would lead to poor bubble stability during processing. Other polyethylene polymers are known, such as linear low density polyethylene (LLDPE) and low density polyethylene (LDPE), both of which have certain properties that can be advantageous and other properties that can be disadvantageous for processing.

LLDPE is a substantially linear polymer made of ethylene monomeric units and alpha-olefin comonomeric units such as 1-butene or 1-hexene. Unlike conventional LDPE which contains a relatively large number of long chain branches extending from the polymer backbone, LLDPE has little or no detectable long chain branching (LCB) per 1,000 carbon atoms. Long chain branching provides reduced neck-in and increased draw stability during extrusion processes. In addition, relative to that of LDPEs, LLDPEs have a narrower molecular weight distribution (MWD), as well as different rheological and mechanical properties, such as tear properties. LLDPE and LDPE are also produced via different manufacturing processes.

LLDPE formed using a metallocene catalyst is known as “mLLDPE”. Extrusions of mLLDPEs typically need more motor power and higher extruder pressures to match the extrusion rates of LDPEs. Typical mLLDPEs also have lower melt strength which, for example, adversely affects bubble stability during blown film extrusion. Typical mLLDPEs are also prone to melt fracture at commercial shear rates. Melt fracture is flow disturbance leading to surface roughness and/or surface irregularities in the extruded resin involving a severe distortion of the extrudate. Melt fracture occurs when shear stress imparted into the resin exceeds the critical shear stress value of that resin or slip-stick flow conditions occur in the die. Melt fracture can be related to high die shear rates (for example, 1,000-60,000 s⁻¹) and shear stresses of such mLLDPEs used to form films. The high shear rates are a result of high line speeds (for example, >600 m/min) used to achieve thin films of the mLLDPE.

For many polyolefin applications, including films, increased melt strength is a desirable attribute. Higher melt strength allows fabricators to run blown film lines at a faster rate to form films of the mLLDPE.

Regardless of the above processing and rheological challenges, mLLDPEs do exhibit superior physical properties as compared to LDPEs. In the past, various levels of LDPE have been blended with mLLDPEs to, for example, increase melt strength, to increase shear sensitivity, to increase flow at commercial shear rates in extruders, and to reduce the tendency to melt fracture. However, such blends generally have poor mechanical properties as compared with neat mLLDPEs. Indeed, it has been a challenge to improve mLLDPEs processability without sacrificing physical properties. Comparing LLDPEs to one another, an LLDPE having a higher melt index is better for processing, and a combination of higher melt index and lower density is particularly good for cast film applications. However, less long chain branching—as presented by conventional LLDPEs—can lead to reduced film properties.

Overall, it is challenging to find a polyethylene copolymer that has a proper balance of melt index and density, while at the same time being commercially processable.

References of potential interest in this regard include: U.S. Pat. Nos. 6,255,426; 7,951,873; 9,718,896; and 10,029,226; US Patent Publication Nos. US2004/0121098; US20070260016; US2015/0232589 and US2020/0339715; as well as U.S. Application Ser. No. 63/362,239.

Thus, there is a need for new polyethylene polymers having a combination of desirable properties (such as density, melt index properties, long chain branching) while also providing commercially desirable processability and extrusions of the polyethylene polymers.

### SUMMARY

The present disclosure generally relates to polyethylene polymers and to articles made therefrom.

In an embodiment, a polyethylene copolymer includes ethylene units, and 1 wt % to 8 wt % of C₃-C₈ alpha-olefin comonomer units. The polyethylene copolymer has a density of 0.934 g/cm³ to 0.945 g/cm³, a melt index (MI, determined per ASTM D1238 at 190° C. and 2.16 kg loading) greater than 0.9 g/10 min and less than or equal to 2.5 g/10 min, a composition distribution breadth index of 75% or greater; a molecular weight distribution (MWD, M_{w}/Mₙ) of 2 to 8, and a melt index ratio (MIR) within the range from 30 to 75, wherein MIR is the ratio of high load melt index (HLMI, ASTM D1238 at 190° C., 21.6 kg) to melt index (MI, ASTM D1238 at 190° C., 2.16 kg)).

In another embodiment, an article includes a polyethylene copolymer. The polyethylene copolymer includes ethylene units, and 1 wt % to 8 wt % of C₃-C₈ alpha-olefin comonomer units. The polyethylene copolymer has a density of 0.934 g/cm³ to 0.945 g/cm³, a melt index (MI, determined per ASTM D1238 at 190° C. and 2.16 kg loading) greater than 0.9 g/10 min and less than or equal to 2.5 g/10 min, a composition distribution breadth index of 75% or greater; a molecular weight distribution (MWD, M_{w}/Mₙ) of 2 to 8, and a melt index ratio (MIR) within the range from 30 to 75, wherein MIR is the ratio of high load melt index (HLMI, ASTM D1238 at 190° C., 21.6 kg) to melt index (MI, ASTM D1238 at 190° C., 2.16 kg)).

In another embodiment, a cast film or a blown film includes a polyethylene copolymer. The polyethylene copolymer has a density of 0.935 g/cm³ to 0.938 g/cm³, and a melt index of 1.1 g/10 min to 1.3 g/10 min.

In another embodiment, a cast film or a blown film includes a polyethylene copolymer. The polyethylene copolymer has a density of 0.935 g/cm³ to 0.938 g/cm³, and a melt index of 1.8 g/10 min to 2.0 g/10 min.

In another embodiment, a lamitube includes a polyethylene copolymer. The polyethylene copolymer has a complex shear viscosity (η*) @ 0.01 rad/sec and 190° C. of 15,000 Pa·s to 25,000 Pa·s, a complex shear viscosity (η*) @ 100 rad/sec and 190° C. of 1,100 Pa·s to 1,300 Pa·s, a density of 0.935 g/cm³ to 0.942 g/cm³, and a melt index of 1 g/10 min to 1.5 g/10 min.

In another embodiment, a hygiene product includes a polyethylene copolymer. The polyethylene copolymer has a complex shear viscosity (η*) @ 0.01 rad/sec and 190° C. of 8,000 Pa·s to 10,000 Pa·s, a complex shear viscosity (η*) @ 100 rad/sec and 190° C. of 900 Pa·s to 1,100 Pa·s, a density of 0.935 g/cm³ to 0.940 g/cm³, and a melt index of 1.5 g/10 min to 2.5 g/10 min.

In another embodiment, a pre-applied waterproofing sheet includes a polyethylene copolymer. The polyethylene copolymer has a density of 0.935 g/cm³ to 0.945 g/cm³, and a melt index of 1.0 g/10 min to 1.5 g/10 min

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a series of gel permeation chromatography chromatograms of example resins and comparative resins according to at least one embodiment of the present disclosure.

FIG. 2 is a graph illustrating viscosity flow curves at 190° C. of example resins and comparative resins according to at least one embodiment of the present disclosure.

FIG. 3 is a graph illustrating Van Gurp Palmen curves for example resins and comparative resins according to at least one embodiment of the present disclosure.

### DETAILED DESCRIPTION

Various embodiments, versions of the disclosed compounds, processes, and articles of manufacture, will now be described, including specific embodiments and definitions that are adopted herein. While the following detailed description gives specific embodiments, those skilled in the art should appreciate that these embodiments are exemplary only, and that embodiments of the present disclosure can be practiced in other ways. Any reference to embodiments may refer to one or more, but not necessarily all, of the compounds, processes, or articles of manufacture defined by the claims. The use of headings is for purposes of convenience only and does not limit the scope of the present disclosure.

The present disclosure generally relates to polyethylene polymers and to articles made therefrom, and more specifically to medium density polyethylene (MDPE) formed using, for example, a metallocene catalyst. MDPEs described herein can be characterized as having a unique balance of chemical, physical, and mechanical properties relative to conventional MDPE, conventional LLDPE, and other conventional polyethylene grades. For example, the MDPEs described herein exhibit a density that is traditionally associated with MDPE and HDPE, while maintaining a small amount of long chain branching traditionally associated with LDPEs (although to a lesser degree than that encountered in LDPEs). Moreover, and as compared to traditional LLDPE and other conventional polyethylene grades, MDPEs of the present disclosure can have a higher melt index, higher viscosity at low shear rates, and improved processability, for example, improved extrudability while maintaining good bubble stability during fabrication processes.

Articles made from such MDPEs are also described. MDPEs described herein can be used in a variety of applications and articles such as, for example, lamitubes, hygiene products, blown breathable films, waterproof sheets, and pipe adhesives, among others.

The MDPEs described herein are polyethylene copolymers. As compared to conventional LLDPEs, polyethylene copolymers of the present disclosure can maintain a small amount of long chain branching (also referred to as “LCB”) in the copolymers providing reduced neck-in and increased draw stability. Polyethylene copolymers of the present disclosure can exhibit lower zero shear viscosity, leading to lower motor torque and lower melt pressures and melt temperatures during extrusion, providing increased output of the extruded polyethylene copolymer product. In addition, because LCB is maintained, advantageous processing properties are likewise maintained. The small amount of LCB can be evidenced through, for example, a high melt index ratio and/or particular rheology characteristics as shown through data obtained by small angle oscillatory shear (SAOS) experiments (for instance, ratio of η_{0.01}/η₁₀₀, the complex viscosity recorded at shear rates of 0.01 and 100 rad/s, respectively).

In addition, it has been discovered that polyethylene copolymers of the present disclosure can provide excellent shear thinning characteristics with little or no melt fracture of the extrudate at high die shear rates. For example, polyethylene copolymers of the present disclosure having small amount of LCB in combination with an MI of about 1 to about 2.5 g/10 min and a density of about 0.930 to about 0.945 g/cm³ can provide blown films having excellent bubble stability (little or no melt fracture) which allows polymer processing aids (such as per- or poly-fluoro alkanes) to be optional in blown films of the present disclosure.

### Definitions

As used herein, an “olefin,” alternatively referred to as “alkene,” is a linear, branched, or cyclic compound of carbon and hydrogen having at least one double bond. For purposes of this specification and the claims appended thereto, when a polymer or copolymer is referred to as “comprising” an olefin, the olefin present in such polymer or copolymer is the polymerized form of the olefin. For example, when a copolymer is described as having an “ethylene” content of 35 wt % to 55 wt %, it is understood that the mer unit in the copolymer is derived from ethylene in the polymerization reaction and the derived units are present at 35 wt % to 55 wt %, based upon the weight of the copolymer.

As used herein, the terms “polyethylene polymer,” “polyethylene,” “ethylene polymer,” “ethylene copolymer,” and “ethylene based polymer” mean a polymer or copolymer comprising at least 50 mol % ethylene units, or at least 70 mol % ethylene units, or at least 80 mol % ethylene units, or at least 90 mol % ethylene units, or at least 95 mol % ethylene units or 100 mol % ethylene units (in the case of a homopolymer).

As used herein, a “polymer” may refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other.

As used herein, a “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like.

As used herein, an ethylene polymer having a density of 0.925 to 0.945 g/cm³ is referred to as a “medium density polyethylene” (MDPE) when substantially linear (having minor or no long chain branching); an ethylene polymer having a density of 0.910 to 0.925 g/cm³ is referred to as a “linear low density polyethylene” (LLDPE) when substantially linear (having minor or no long chain branching) as is typically the case for Ziegler-Nata or metallocene-catalyzed PE or branched low density polyethylene (LDPE) when significantly branched (having a high degree of long chain branching), as is often the case with free-radical polymerized PE; and an ethylene polymer having a density of more than 0.945 g/cm³ is referred to as a “high density polyethylene” (HDPE).

Density is determined according to ASTM D1505. Specimens are prepared according to ASTM D4703—Annex 1 Procedure C followed by conditioning according to ASTM D618—Procedure A prior to testing.

As used herein, and unless otherwise specified, the term “Cn” refers to hydrocarbon(s) having n carbon atom(s) per molecule, wherein n is a positive integer.

As used herein, and unless otherwise specified, the term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated or unsaturated), including mixtures of hydrocarbon compounds having different values of n.

As used herein, the term “film” refers to a continuous, flat (in some instances, flexible) polymeric structure having an average thickness of a range of 0.1, or 1, or 5, or 10, or 15, or 20 μm to 50, or 75, or 100, or 150, or 200, or 250, or 1000, or 2000 μm, or such a coating of similar thickness adhered to a flexible, non-flexible or otherwise solid structure. The “film” may be made from or contain a single layer or multiple layers. Each layer may be made from or contain the polyethylene copolymers of the present disclosure. For example, one or more layers of a “film” may include a mixture of the disclosed polyethylene copolymer as well as a LDPE, LLDPE, another MDPE, HDPE, polypropylene, or a plastomer.

As used herein, a composition or film “free of” a component refers to a composition/film substantially devoid of the component, or comprising the component in an amount of less than about 0.01 wt %, by weight of the total composition.

As used herein, the term “polymerizable conditions” refers to conditions conducive to the reaction of one or more olefin monomers when contacted with an activated olefin polymerization catalyst to produce a polyolefin polymer, including a skilled artisan's selection of temperature, pressure, reactant concentrations, optional solvent/diluents, reactant mixing/addition parameters, and other conditions within at least one polymerization reactor.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, “in a range” or “within a range” includes every point or individual value between its end points even though not explicitly recited and includes the end points themselves. Thus, every point or individual value may serve as its own lower or upper limit combined with any other point or individual value or any other lower or upper limit, to recite a range not explicitly recited.

The term “terminal olefin” refers to an olefin having a terminal carbon-to-carbon double bond in the structure thereof ((R¹R²)—C═CH₂, where R¹ and R² can be independently hydrogen or any hydrocarbyl group, such as R¹ is hydrogen, and R² is an alkyl group). A “linear terminal olefin” is a terminal olefin defined in this paragraph wherein R¹ is hydrogen, and R² is hydrogen or a linear alkyl group.

The term “vinyl” refers to an olefin having the following formula:

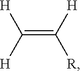

wherein R is a hydrocarbyl group, such as a saturated hydrocarbyl group such as an alkyl group.

The term “vinylidene” refers to an olefin having the following formula:

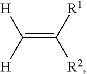

wherein each of R¹ and R² are, independently, a hydrocarbyl group, such as a saturated hydrocarbyl group such as alkyl group.

The term “vinylene” or “1,2-di-substituted vinylene” refers to
(i) an olefin having the following formula:

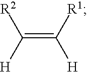

or
(ii) an olefin having the following formula:

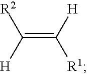

or
(iii) a mixture of (i) and (ii) at any proportion thereof, wherein each of R¹ and R² are, independently, a hydrocarbyl group, such as saturated hydrocarbyl group such as alkyl group.

The term “tri-substituted vinylene” refers to an olefin having the following formula:

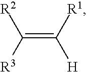

wherein each of R¹, R², and R³ are, independently, a hydrocarbyl group, such as a saturated hydrocarbyl group such as alkyl group.

### Polyethylene Copolymers

Embodiments of the present disclosure provide polyethylene copolymers such as MDPEs. The MDPEs described herein exhibit a density that is traditionally associated with conventional MDPE and conventional HDPE, while maintaining a small amount of long chain branching traditionally associated with LDPEs (although to a lesser extent than seen in LDPEs). Embodiments of MDPEs presented herein can also have a high melt index while additionally providing higher viscosities at low shear rates, illustrating a benefit over conventional polyethylene grades. Moreover, and relative to conventional polyethylene grades, MDPEs described herein can exhibit improved processability, for example, improved extrudability while maintaining good bubble stability during blown film fabrication processes.

Thus, polyethylene copolymers of various embodiments herein can exhibit one or more of the following properties:
A density within the range from 0.930 to 0.945, such as from about low of any one of 0.931, 0.932, 0.933, 0.934, 0.935, 0.936, 0.937, or 0.938 g/cm³ to a high of any one of 0.945, 0.944, 0.943, 0.942, 0.941, 0.940, 0.939, 0.938, or 0.937/cm³, such as from 0.934 to 0.937 g/cm³, or from 0.937 to 0.940 g/cm³, or from 0.940 to 0.945 g/cm³, with combinations from any low to any high contemplated (provided the high end is greater than the low end), for example, from 0.934 to 0.945 g/cm³, from 0.935 to 0.938 g/cm³ or from 0.935 to 0.937 g/cm³, though other densities are contemplated. Density is determined according to ASTM D1505-19.
A melt index (MI, also referred to as I₂ or I_{2.16} in recognition of the 2.16 kg loading used in the test) greater than 0.9 g/10 min (ASTM D1238, 190° C., 2.16 kg), such as within the range from a low of any one of 1, 1.1, 1.2, 1.3, 1.4, 1.5, 1.6, 1.7, 1.8, or 1.9 g/10 min to a high end of any one 2.5, 2.4, 2.3, 2.2, 2.1, 2, 1.9, 1.8, 1.7, or 1.6 g/10 min, with ranges from any low end to any high end contemplated herein (provided the high end is greater than the low end), such as from 0.9 to 2.5 g/10 min, such as from 1 to 2 g/10 min, such as from 1.1 to 1.3 g/10 min or from 1.8 to 2 g/10 min, though values (or ranges) of MI are contemplated.
A comonomer distribution reflecting a similar degree of comonomer incorporation on polymer chains of varying length of the polyethylene copolymer, which is quantified in the composition distribution breadth index (CDBI). For instance, polyethylene comonomers of various embodiments have CDBI of 70% or more, such as 75% or more, such as 80% or more, 85% or more, or even 90% or more, though other values (or ranges) of CBDI are contemplated. CDBI is defined as the weight percent of the copolymer molecules having a comonomer content within 50% of the median total molar comonomer content (i.e., within +/−50% of the median; or in other words, within a range from 0.5× median to 1.5× median), and it is referenced, for example, in U.S. Pat. No. 5,382,630. In general, copolymers with a broader distribution result in a lower CDBI, while a theoretical copolymer with exactly the same relative comonomer content across all different lengths of polymer chains would have a CDBI of 100%. The CDBI of a copolymer is readily determined utilizing a technique for isolating individual fractions of a sample of the copolymer. One such technique is generation of a solubility distribution curve using Temperature Rising Elution Fraction (TREF), as described in WO 1993003093 (which in turn references Wild, et al., J. Poly. Sci., Poly. Phys. Ed., vol. 20, p. 441 (1982) and U.S. Pat. No. 5,008,204 in this regard). All three of the foregoing publications are incorporated herein by reference. Alternatively, the narrow comonomer distribution can be reflected in the T₇₅−T₂₅ value, wherein T₂₅ is the temperature at which 25% of the eluted polymer is obtained and T₇₅ is the temperature at which 75% of the eluted polymer is obtained, both in a TREF experiment as described in US2019/0119413 (especially in paragraphs [0055]-[0058] thereof, which description is incorporated by reference herein). A narrow distribution is reflected in the relatively small difference in the T₇₅−T₂₅ value being less than 10° C., such as within the range from 1 to 10° C., such as from 2 to 10° C., for example from a low of any one of 1, 1.5, 2, 2.5, 3, 3.5, 4, 4.5, 5, 5.5, or 6° C. to a high of any one of 10, 9.5, 9, 8.5, 8, 7.5, 7, or 6.5° C., such as from 1.5 to 4° C., 2 to 3.5° C., alternatively 4 to 10° C., with combinations from any low to any high contemplated (provided the high end is greater than the low end), though other T₇₅−T₂₅ values are contemplated.

The polyethylene copolymer may be the polymerization product of an ethylene monomer and one or more olefin comonomers, such as alpha-olefin comonomers. Alpha-olefin comonomers can have 3 to 12 carbon atoms, or from 4 to 10 carbon atoms, or from 4 to 8 carbon atoms. Olefin comonomers can be selected from the group consisting of propylene, 1-butene, 1-pentene, 1-hexene, 1-heptene, 1-octene, 4-methylpent-1-ene, 1-nonene, 1-decene, 1-undecene, 1-dodecene, 1-hexadecene, and the like, and any combination thereof, such as 1-butene, 1-hexene, and/or 1-octene. In some embodiments, a polyene is used as a comonomer. In some embodiments, the polyene is selected from the group consisting of 1,3-hexadiene, 1,4-hexadiene, cyclopentadiene, dicyclopentadiene, 4-vinylcyclohex-1-ene, methyloctadiene, 1-methyl-1,6-octadiene, 7-methyl-1,6-octadiene, 1,5-cyclooctadiene, norbornadiene, ethylidene norbornene, 5-vinylidene-2-norbornene, 5-vinyl-2-norbornene, and olefins formed in situ in the polymerization medium. In some embodiments, comonomers are selected from the group consisting of isoprene, styrene, butadiene, isobutylene, chloroprene, acrylonitrile, and cyclic olefins. In some embodiments, combinations of the olefin comonomers are utilized. In some embodiments, the olefin comonomer is selected from the group consisting of 1-butene and 1-hexene. The olefin comonomer content of the polyethylene copolymer can range from a low of about 0.1, 1, 1.5, 2, 2.5, 3, 3.5, 4, 4.5, 5, 5.5, 6, 6.5, 7, 7.5, 8, or 8.5 wt % to a high of about 20, 15, 13, 12.5, 12, 11.5, 11, 10.5, 10, 9.5, or 9 wt %, on the basis of total weight of monomers in the polyethylene copolymer. The balance of the polyethylene comonomer is made up of units derived from ethylene (for example, from a low of 80, 85, 88, 90, 91, 92, 92.5, 93, 93.5, or 94 wt % to a high of 90, 91, 92, 92.5, 93, 93.5, 94, 94.5, 95, 95.5, 96, 97, 99, or 99.9 wt %). Ranges from any foregoing low end to any foregoing high end are contemplated herein (for example, 88 to 93 wt %, such as 90 to 92.0 wt % ethylene-derived units and the balance olefin comonomer-derived content).

The polyethylene copolymers can also have a high load melt index (HLMI) (also referred to as I₂₁ or I_{21.6} in recognition of the 21.6 kg loading used in the test) within the range from a low of 35, 40, 45, 50, or 55 g/10 min to a high of 80, 75, 70, 65, 60 or 55 g/10 min, with ranges from any of the foregoing lows to any of the foregoing highs contemplated herein (for example, 35 to 80 g/10 min, or from 45 to 70 g/10 min, or from 40 to 50 g/10 min, or from 55 to 65 g/10 min, or from 65 to 80 g/10 min or from 70 to 80 g/10 min). The term “high load melt index” (“HLMI”), is the number of grams extruded in 10 minutes under the action of a standard load (21.6 kg) and is an inverse measure of viscosity. As provided herein, HLMI (121) is determined according to ASTM D1238 (190° C./21.6 kg) and is also sometimes referred to as I₂₁ or I_{21.6}.

The polyethylene copolymers can also have a melt index ratio (MIR, defined as the ratio of I_{21.6}/I_{2.16}) within the range from a low of any one of 25, 30, 35, 40, 45, 50, or 55 to a high of any one of 80, 75, 70, 65, 60, 55, or 50, with ranges from any of the foregoing lows to any of the foregoing highs contemplated herein, such as within the range from any low of 30, 31, 32, 33, 34, 35, 36, 37, 38, 39, 40, or 41 to a high of any one of 51, 50, 49, 48, 47, 46, 45, 44, 43, 42, 41, or 40 with ranges from any of the foregoing lows to any of the foregoing highs contemplated herein (for example, from 35 to 45, from 37 to 44, from 37 to 40, or from 40 to 44). MIR is the ratio of I₂₁/I₂.

The polyethylene copolymers can also have a molecular weight distribution (MWD) that is from 2 to 8. The MWD can also range from a low of 2, 2.5, 3, 3.1, 3.2, 3.3, 3.4, 3.5, 3.6, 3.7, 3.8, 3.9, or 4 to a high of 3.5, 3.6, 3.7, 3.8, 3.9, 4, 4.1, 4.2, 4.3, 4.4, 4.5, 5, 6, or 8, with ranges from any foregoing low to any foregoing high contemplated, provided the high end of the range is greater than the low end, such as from 2 to 5, or from 3 to 6, or from 3.5 to 5, or from 4 to 4.5. MWD is defined as the weight average molecular weight (M_{w}) divided by number-average molecular weight (Mₙ), (M_{w}/Mₙ).

A weight-average molecular weight (M_{w}) of polyethylene copolymers of various embodiments may be within the range from 70,000 to 90,000 g/mol, such as from 75,000 to 85,000 g/mol, such as from 75,000 to 80,000 g/mol, alternatively from 80,000 to 85,000 g/mol, with ranges from any foregoing low end to any foregoing high end contemplated.

A number-average molecular weight (Mₙ) of polyethylene copolymers of various embodiments may be within the range from 15,000 to 30,000 g/mol, such as from 15,000 to 25,000 g/mol, or from 17,000 to 21,000 g/mol, or from 18,000 to 20,000 g/mol, with ranges from any foregoing low end to any foregoing high end contemplated.

A Z-average molecular weight (M_{z}) of polyethylene copolymers of various embodiments may be within the range from 150,000 to 210,000 g/mol, such as from 155,000 to 205,000 g/mol, 160,000 to 200,000 g/mol, such as from 165,000 to 195,000 g/mol, from 170,000 to 190,000 g/mol, or from 175,000 to 185,000 g/mol, with ranges from any foregoing low end to any foregoing high end contemplated (for example, from 190,000 to 205,000 g/mol, or from 180,000 to 185,000 g/mol, or from 165,000 to 175,000 g/mol, or from 165,000 to 170,000 g/mol).

Polyethylene copolymers of various embodiments may also exhibit a small (but non-zero) amount of long-chain branching. As noted previously, this may be evidenced through, for example, SAOS viscosity data (especially η_{0.01}/η₁₀₀) and/or MIR. Further, a LCB index (g′ or alternatively g′ᵥᵢₛ) could be less than 1, such as within the range from 0.9 to 0.99 or from 0.96 to 0.985, although still substantially higher than g′ for heavily-LCB polyethylene, such as LDPE made using free radical polymerization.

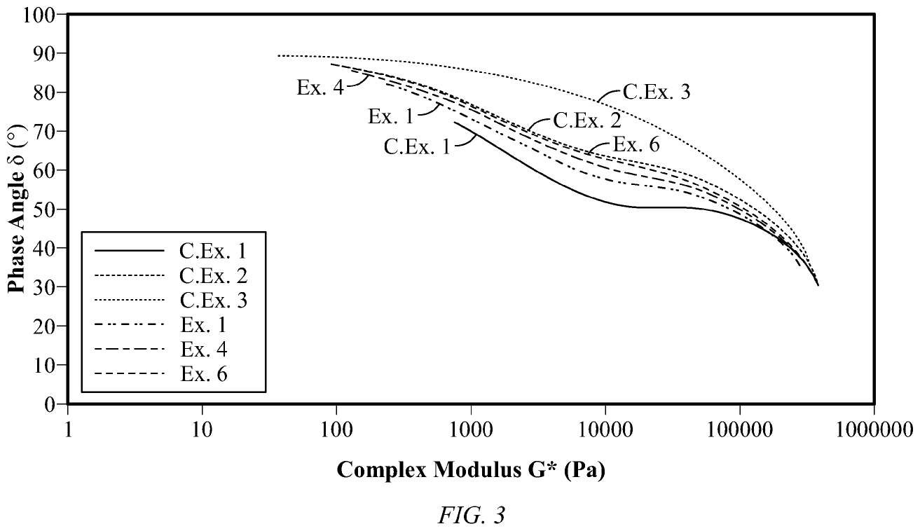

Another useful parameter for indicating the presence of LCB is illustrated in FIG. 3 (discussed in more detail in connection with the Examples, below): Van Gurp Palmen plots. In particular, polyethylene copolymers (even LLDPE) with some LCB will exhibit an inflection point in their Van Gurp Palmen curve, while LLDPE without any LCB present (for example, comparative resin 3 of FIG. 3) show no such inflection point.

The distributions and the moments of molecular weight (Mw, Mn, Mw/Mn, etc.), and the branching index (g′ᵥᵢₛ) are determined by using a high temperature Gel Permeation Chromatography (Polymer Char GPC-IR) equipped with a multiple-channel band-filter based Infrared detector IR5, an 18-angle Wyatt Dawn Heleos light scattering detector and a 4-capillary viscometer with Wheatstone bridge configuration. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and viscometer detector are contained in ovens maintained at 145° C. The polymer sample is weighed and sealed in a standard vial with 80-μL flow marker (Heptane) added to it. After loading the vial in the autosampler, polymer is automatically dissolved in the instrument with 8 ml added TCB solvent. The polymer is dissolved at 160° C. with continuous shaking for about 2 hour. The concentration (c), at each point in the chromatogram is calculated from the baseline-subtracted IR5 broadband signal intensity (I), using the following equation:

$$c = β I ,$$

where β is the mass constant.

The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 million g/mol. The MW at each elution volume is calculated with the following equation:

$$log M = \frac{log ( {K}_{PS} / K )}{a + 1} + \frac{{a}_{PS} + 1}{a + 1} log {M}_{PS} ,$$

where the variables with subscript “PS” stand for polystyrene while those without a subscript are the test samples. In this method, a_{PS}=0.67 and K_{PS}=0.000175 while a and K are for ethylene-hexene copolymers as calculated from empirical equations (Sun, T. et al. Macromolecules 2001, 34, 6812), in which a=0.695 and K=0.000579 (1-0.75 Wt), where Wt is the weight fraction for hexane comonomer. It should be noted that the comonomer composition is determined by the ratio of the IR5 detector intensity corresponding to CH2 and CH3 channel calibrated with a series of PE and ethylene-hexene homo/copolymer standards whose nominal values are predetermined by NMR or FTIR. Here the concentrations are expressed in g/cm³, molecular weight is expressed in g/mol, and intrinsic viscosity (hence K in the Mark-Houwink equation) is expressed in dL/g.

The LS molecular weight (M) at each point in the chromatogram is determined by analyzing the LS output using the Zimm model for static light scattering

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}} ,$$

where NA is Avogadro's number, and (dn/dc) is the refractive index increment for the system. The refractive index, n=1.500 for TCB at 145° C. and λ=665 nm. For purposes of the present disclosure and the claims thereto (dn/dc)=0.1048 for ethylene-hexene copolymers.

A high temperature Polymer Char viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η]_{avg}, at each point in the chromatogram is calculated from the equation [η]=ηₛ/c, where c is concentration and is determined from the IR5 broadband channel output.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}} ,$$

where the summations are over the chromatographic slices, i, between the integration limits. The branching index g′ᵥᵢₛ is defined as:

$${g}_{vis}^{′} = \frac{{[ η ]}_{avg}}{{KM}_{v}^{α}} ,$$

where M_{ν} is the viscosity-average molecular weight based on molecular weights determined by LS analysis and the K and α are for the reference linear polymer, which are, for purposes of the present disclosure, α and K are the same as described above for linear polyethylene polymers.

Furthermore, the polyethylene copolymers can have a complex shear viscosity (η*) @ 0.01 rad/sec and 190° C. in the range of 8,000 to 25,000 Pa·s, such as from a low of any one of 8,000, 9,000, 10,000, 11,000, 12,000, 13,000, 14,000, 15,000, or 16,000 Pa·s to a high of any one of 25,000, 24,000, 23,000, 23,000, 21,000, 20,000, 19,000, 18,000, 17,000, or 16,000 Pa·s, with ranges from any low end to any high end contemplated (for example, from 8,000 to 10,000 Pa·s or from 15,000 to 25,000 Pa·s).

Complex shear viscosity (η*) @ 100 rad/sec and 190° C. may be in the range from 900 to 1,500 Pa·s, such as from a low of any one of 900, 1,000, 1,100, or 1,200 Pa·s to a high of any one of 1,500, 1,400, 1,300, 1,200 or 1,100 Pa·s, with ranges from any foregoing low to any foregoing high also contemplated (for example, from 900 to 1,100 Pa·s or from 1,100 to 1,300 Pa·s).

In some embodiments, the polyethylene copolymer has a shear thinning ratio (η* @ 0.01/100) that is less than 20, or in the range from 5 to 20, such as from a low of any one of 7, 8, 9, 10, 11, 12, 13, or 14 to a high of any one of 20, 19, 18, 17, 16, 15, 14, or 13, with ranges from any foregoing low to any foregoing high also contemplated (for example, from 8 to 10, or from 12 to 13, or from 17 to 19)

Rheological data such as “Complex shear viscosity (η*),” reported in Pascal seconds, can be measured at 0.01 rad/sec and 100 rad/sec. Complex shear viscosity and other rheological measurements can be obtained from small angle oscillatory shear (SAOS) experiments.

For instance, complex shear viscosity can be measured with a rotational rheometer such as an Advanced Rheometrics Expansion System (ARES-G2 model) or Discovery Hybrid Rheometer (DHR-3 Model) using parallel plates (diameter=25 mm) in a dynamic mode under nitrogen atmosphere. The rheometer can be thermally stable at 190° C. for at least 20 minutes before inserting compression-molded specimen onto the parallel plates. To determine the specimen's viscoelastic behavior, a frequency sweep in the range from 0.01 to 628 rad/s can be carried out at a temperature of 190° C. under constant strain that does not affect the measured viscoelastic properties. The sweep frequencies are equally spaced on a logarithmic scale, so that 5 frequencies are probed per decade. Depending on the molecular weight and temperature, strains of 3% can be used and linearity of the response is verified. A nitrogen stream is circulated through the oven to minimize chain extension or cross-linking during the experiments. The specimens can be compression molded at 190° C., without stabilizers. A sinusoidal shear strain can be applied. The shear thinning slope (STS) can be measured using plots of the logarithm (base ten) of the dynamic viscosity versus logarithm (base ten) of the frequency. The slope is the difference in the log (dynamic viscosity) at a frequency of 100 s⁻¹ and the log (dynamic viscosity) at a frequency of 0.01 s⁻¹ divided by 4. The complex shear viscosity (η*) versus frequency (ω) curves can be fitted using the Carreau-Yasuda model:

$${η}^{*} - η∞ = ( {η}_{0} - η∞ ) * {( 1 + {( λω )}^{a} )}^{( n - 1 ) / a} .$$

The five parameters in this model are: η₀, the zero-shear viscosity; λ, the relaxation time; and n, the power-law index; η∞, the infinite rate viscosity; and a, the transition index. The zero-shear viscosity is the value at a plateau in the Newtonian region of the flow curve at a low frequency, where the dynamic viscosity is independent of frequency. The relaxation time corresponds to the inverse of the frequency at which shear-thinning starts. The power-law exponent describes the extent of shear-thinning, in that the magnitude of the slope of the flow curve at high frequencies approaches n−1 on a log(η*)−log(ω) plot. For Newtonian fluids, n=1 and the dynamic complex viscosity is independent of frequency.

In addition to dynamic and complex viscosity (each in Pascal seconds), at each frequency sweep in the SAOS experiment, various other parameters are collected, including storage modulus (Pa), Loss modulus (Pa), Complex Modulus (Pa), tan (delta), and phase angle. Charting the phase angle versus the complex shear modulus from the rheological experiment yields van Gurp Palmen plots useful to extract some information on the molecular characteristics, for example, linear vs. long chain branched chains, type of long chain branching, polydispersity (Dealy, M. J., Larson, R. G., “Structure and Rheology of Molten Polymers”, Carl Hanser Verlag, Munich 182-183 (2006). It has been also suggested that Van Gurp Palmen plots can be used to reveal the presence of long chain branching in polyethylene. See Trinkle, S., Walter, P., Friedrich, C. “Van Gurp-Palmen plot II—Classification of long chain branched polymers by their topology”, in 41 Rheol. Acta 103-113 (2002).

“Shear Thinning Ratio”, which is reported as a unitless number, is characterized by the decrease of the complex viscosity with increasing shear rate. Herein, shear thinning can be determined as a ratio of complex viscosity at a frequency of 0.01 rad/s to the complex viscosity at a frequency of 100 rad/s.

A balance of some of the advantageous properties of polyethylene copolymers of the present disclosure may furthermore be represented by one or more overall properties, such as an “α parameter”, a “β parameter”, or combinations thereof.

The α parameter is represented by Equation 1:

$$α parameter = ( MIR * {η}_{0.01} / {η}_{100} ) * ( {T}_{75} - {T}_{25} ) / MWD \qquad ( Eq . 1 )$$

The β parameter is represented by Equation 2:

$$β parameter = ( MIR * {η}_{0.01} / {η}_{100} ) * {( ( {T}_{75} - {T}_{25} ) / MWD )}^{2} \qquad ( Eq . 2 )$$

In Equations 1 and 2, MIR is melt index ratio, η_{0.01} is complex shear viscosity (η*) @ 0.01 rad/sec and 190° C., η₁₀₀ is complex shear viscosity (η*) @ 100 rad/sec and 190° C., T₇₅−T₂₅ is T₇₅−T₂₅ value, where T₂₅ is the temperature at which 25% of the eluted polymer is obtained and T₇₅ is the temperature at which 75% of the eluted polymer is obtained (determined by TREF, as referenced above), and MWD is molecular weight distribution.

Polyethylene copolymers of various embodiments of the present disclosure have an α parameter (Equation 1) that is from 230 to 1,000, such as from 240 to 500, such as from 240 to 300, or from 240 to 250, or from 290 to 330, or from 440 to 500, with ranges from any foregoing low to any foregoing high also contemplated. Overall, the α parameter shows the strong dependence on long chain branching, and thus the α parameter captures the uniqueness of the combination of these properties exhibited in the polyethylene copolymers of the present disclosure.

Polyethylene copolymers of the present disclosure can have a β parameter (Equation 2) that is from 120 to 400, such as from 150 to 350, such as from 170 to 200, or from 190 to 230, or from 260 to 310, with ranges from any foregoing low to any foregoing high also contemplated. Overall, the β parameter shows the strong dependence on the breadth of the co-monomer distribution (through the T₇₅−T₂₅ term), and thus the β parameter captures the uniqueness of the combination of these properties exhibited in the polyethylene copolymers of the present disclosure.

The polyethylene copolymers can have a vinylene content that is from 0.05 to 0.1 vinylenes/1000 carbon atoms, such as from 0.06 to 0.09 vinylenes/1000 carbon atoms, such as from 0.07 to 0.08 vinylenes/1000 carbon atoms, with ranges from any foregoing low to any foregoing high also contemplated (for example, from 0.07 to 0.1 vinylenes/1000 carbon atoms or from 0.08 to 0.09 vinylenes/1000 carbon atoms).

The polyethylene copolymers can have a trisubstituted vinylene content that is from 0.03 to 0.15 trisubstituted vinylenes/1000 carbon atoms, such as from 0.09 to 0.15 trisubstituted vinylenes/1000 carbon atoms, such as from 0.1 to 0.15 trisubstituted vinylenes/1000 carbon atoms, or from 0.09 to 0.1 trisubstituted vinylenes/1000 carbon atoms, or from 0.1 to 0.12 trisubstituted vinylenes/1000 carbon atoms, or from 0.12 to 0.14 trisubstituted vinylenes/1000 carbon atoms, with ranges from any foregoing low to any foregoing high also contemplated (for example 0.09 to 0.12 trisubstituted vinylenes/1000 carbon atoms).

The polyethylene copolymers can have a vinyl content that is from 0.01 to 0.02 vinyls/1000 carbon atoms, such as from 0.012 to 0.018 vinyls/1000 carbon atoms, such as from 0.014 to 0.016 vinyls/1000 carbon atoms, with ranges from any foregoing low to any foregoing high also contemplated.

In some embodiments, the polyethylene copolymers have a vinylidene content of 0.005 vinylidenes/1000 carbon atoms or less, such as 0 vinylidenes/1000 carbon atoms.

The polyethylene copolymers can have a total unsaturation that is from 0.1 to 0.25, such as from 0.17 to 0.23, such as from a low of any one of 0.17, 0.18, 0.19, or 0.20 to a high of any one of 0.23, 0.22, 0.21, or 0.20, with ranges from any low end to any high end contemplated (for example, from 0.17 to 0.22, or from 0.18 to 0.2, or from 0.21 to 0.23). Total unsaturation is the sum of vinylenes/1000 carbon atoms, trisubstituted vinylenes (olefins)/1000 carbon atoms, vinyls/1000 carbon atoms, and vinylidenes/1000 carbon atoms.

¹H NMR data can be collected at 120° C. in a 10 mm probe using a spectrometer with a ¹H frequency of 600 MHz or higher. Data can be recorded using a maximum pulse width of 45°, 5 seconds between pulses and signal averaging 512 transients. Spectral signals are integrated. Polyethylene copolymer samples can be dissolved in deuterated 1,1,2,2,-tetrachloroethane-d2 at concentrations of 30 mg/ml prior to being inserted into the spectrometer magnet. Prior to data analysis, spectra can be referenced by setting the residual hydrogen-containing solvent resonance to 5.98 ppm. Disubstituted vinylenes can be measured as the number of vinylenes per 1,000 carbon atoms using the resonances between 5.55-5.31 ppm. Trisubstituted vinylenes (“trisubs”) end-groups can be measured as the number of trisubstituted groups per 1,000 carbon atoms using the resonances between 5.3-5.11 ppm, by difference from vinyls. Vinyl end-groups can be measured as the number of vinyls per 1,000 carbon atoms using the resonances between 5.10-4.95 and between 5.3-4.85 ppm. Vinylidene end-groups can be measured as the number of vinylidenes per 1,000 carbon atoms using the resonances between 4.84-4.70 ppm.

As used herein, a “triad” is a three monomer repeat unit: for example, AAA, AAB, BAA, BAB, ABA, BBA, ABB, BBB summed and normalized to 1. A=CH₂; B=C₆. Triad analysis by ¹³C-NMR gives insight into the sequence distribution and the blockiness of the material. In some embodiments, a polyethylene copolymer has an [EEE] triad content that is from 95 to 99 mol %, such as from 95 to 98 mol %, such as from 95.5 to 97.5 mol %, such as from 96 to 97 mol %, such as from 96 to 96.5 mol % or from 96.5 to 97 mol %, with ranges from any low end to any high end contemplated (for example, from 97 to 97.5 mol %), as determined by ¹³C nuclear magnetic resonance (¹³C NMR). (“E” is ethylene). In some embodiments, a polyethylene copolymer has an [HEE] triad content of 1.4 to 2.5 mol %, such as from 1.5 to 2.5 mol % or from 1.4 to 2.2 mol %, such as from 1.7 to 2.2 mol %, such as from 1.7 to 1.8 mol %, or from 1.8 to 2.1 mol %, or from 2 to 2.1 mol %, with ranges from any low end to any high end contemplated, as determined by ¹³C NMR). (“H” is hexene and “E” is ethylene).

In some embodiments, a polyethylene copolymer has an [EHE] triad content of 0.7 to 1 mol %, such as from 0.8 mol % to 1 mol %, such as 0.8 mol % to 0.9 mol % or from 0.9 to 1 mol %, as determined by ¹³C NMR. In some embodiments, a polyethylene copolymer has an [HHH] triad content of 0.0 mol % to 0.1 mol %, such as less than 0.1 mol % or less than 0.05 mol %, or less than 0.01 mol %, as determined by ¹³C NMR. In some embodiments, a polyethylene copolymer has an [HEH] triad content of less than 0.05 mol %, as determined by ¹³C NMR. In some embodiments, a polyethylene copolymer has an [EHH] triad content of less than 0.05 mol %, as determined by ¹³C NMR.

For ¹³C NMR samples can be dissolved in deuterated 1,1,2,2-tetrachloroethane-d2 (tce-d2) at a concentration of 67 mg/mL at 140° C. Spectra can be recorded at 120° C. using a Bruker NMR spectrometer of at least 600 MHz with a 10 mm cryoprobe. A 90° pulse, 10 second delay, 512 transients, and gated decoupling can be used for measuring the ¹³C NMR. Polymer resonance peaks are referenced to Polyethylene main peak at 29.98 ppm. Chemical shift assignments for the ethylene based copolymers are described by Randall in “A Review Of High Resolution Liquid Carbon Nuclear Magnetic Resonance Characterization of Ethylene-Based Polymers”, Polymer Reviews, 29:2,201-5 317 (1989). The copolymer content, mole and weight %, triad sequencing, and diad calculations are also calculated and described in the method established by Randall in this paper.

### Waste-Processed Olefins

The processing of waste, such as plastic waste, may result in the production or recovery of olefins, or the attribution of waste feedstock to olefins, including any of the alpha-olefins disclosed herein, used in making the polymer compositions (for example, polyethylene copolymers) disclosed herein. The waste may include plastic waste obtained from any source including, but not limited to, municipal, industrial, commercial or consumer sources. The plastic waste further may be obtained from a common source or from mixed sources, including mixed plastic waste obtained from municipal or regional sources and/or from waste streams of polyethylene terephthalate (PET), HDPE, MDPE, LDPE, LLDPE, polypropylene, and/or polystyrene. Furthermore, the waste may include thermoplastic elastomers and thermoset rubbers, such as from tires and other articles made from natural rubber, polybutadiene, styrene-butadiene, butyl rubber and EPDM.

The waste that is processed may also include any of various used polymeric and non-polymeric articles without limitation. Some examples of the many types of polymeric articles may include: films (including cast, blown, and otherwise), sheets, fibers, woven and nonwoven fabrics, furniture (for example, garden furniture), sporting equipment, bottles, food and/or liquid storage containers, transparent and semi-transparent articles, toys, tubing and pipes, sheets, packaging, bags, sacks, coatings, caps, closures, crates, pallets, cups, non-food containers, pails, insulation, and/or medical devices. Further examples include automotive, aviation, boat and/or watercraft components (for example, bumpers, grills, trim parts, dashboards, instrument panels and the like), wire and cable jacketing, agricultural films, geomembranes, playground equipment, and other such articles, whether blow molded, roto-molded, injection-molded, or the like. Any of the foregoing may include mixtures of polymeric and non-polymeric items (for example, packaging or other articles may include inks, paperboards, papers, metal deposition layers, and the like). The ordinarily skilled artisan will appreciate that such polymeric articles may be made from any of various polymer and/or non-polymer materials, and that the polymer materials may vary widely (for example, ethylene-based, propylene-based, butyl-based polymers, and/or polymers based on any C₂ to C₄₀ or even higher olefins, and further including polymers based on any one or more types of monomers, for example, C₂ to C₄₀ α-olefin, di-olefin, cyclic olefin, etc. monomers). Common examples include ethylene, propylene, butylene, pentene, hexene, heptene, and octene; as well as multi-olefinic (including cyclic olefin) monomers such as ethylidene norbornene (ENB) and vinylidene norbornene (VNB) (including, for example, when such cyclic olefins are used as comonomers, for example, with ethylene monomers).

Processing of waste, such as through the pyrolysis of plastic waste, may directly produce or recover olefins used to make such polymer compositions or via the attribution of the use of the waste as a feed to a system, such as determined by crediting, allocating, and/or offsetting or substituting for other hydrocarbons in a mass or energy balance for a system, such as in accordance with a third party certification relating to circularity. Polymers that are certified for their circularity by third party certification may be referred to as certified circular. One example of such a certification is the mass balance chain of custody method set forth by the International Sustainability and Carbon Certification.

Various processes may be employed to produce, recover, or attribute to olefins used for the polymers disclosed herein. For example, olefins may be obtained from or in connection with the co-processing of waste, such as plastic waste, with other hydrocarbon feeds in a cracking, coking, hydroprocessing, and/or pyrolysis processes. For example, the olefins may be obtained directly or indirectly from fluid catalytic cracking units, delayed coking units, fluidized coking units (including FLEXICOKING™ units), hydroprocessing units (including hydrocracking and hydrotreating units), and/or steam cracking units (including gas or liquid steam cracking units) receiving such waste as a feed or co-feed. Alternatively, such units may receive a pyrolysis product of the processing of such waste (such as a separated or combined recycle pyrolysis gas and/or recycle pyrolysis oil) as a feed or cofeed. The olefins may be directly produced by such process or may be obtained by further processing, such as separation, treating, and/or cracking of an effluent of such processes. As an example, the olefins may be obtained by the processing of recycle pyrolysis oil and/or recycle pyrolysis gas produced from the pyrolysis of plastic waste. As used herein “recycle pyrolysis oil” refers to compositions of matter that are liquid when measured at 25° C. and 1 atm, and at least a portion of which are obtained from the pyrolysis of recycled waste (for example, recycled plastic waste). As used herein “recycle pyrolysis gas” refers to compositions of matter that are a gas at 25° C. and 1 atm, and at least a portion of which are obtained from the pyrolysis of recycled waste. In addition, co-processing of waste, such as plastic waste, as a feed or co-feed into fluid catalytic cracking units, delayed coking units, fluidized coking units (including FLEXICOKING™ units), hydroprocessing units (including hydrocracking and hydrotreating units), and/or steam cracking units (including gas or liquid steam cracking units) may result in the attribution of the waste to olefins, polymers, or polymer compositions described herein, such as determined by crediting, allocating, and/or offsetting or substituting for other hydrocarbons in a mass or energy balance for a system, such as in accordance with a third party certification relating to circularity.

Accordingly, processes per various embodiments herein may further include obtaining olefins that have been produced or recovered from the processing of plastic waste or olefins to which the processing of plastic waste has been attributed, for example, for employment in polymerization processes as elsewhere described herein; and polymer compositions (for example, polyethylene copolymer) of various embodiments described herein may comprise olefins that have been produced or recovered from the processing of plastic waste or olefins to which the processing of plastic waste has been attributed. As an example, at least a portion of the olefin content (for example, employed in processes and/or included in compositions as described herein) may be from olefins that are produced or recovered directly from the processing of plastic waste. Similarly, the processing of plastic waste may be attributed to at least a portion the olefins (for example, employed in processes and/or included in compositions as described herein).

### Blends and Additives

In some embodiments, polyethylene copolymers described herein can be formulated (for example, blended) with one or more other polymer components. In some embodiments, those other polymer components are alpha-olefin polymers such as polypropylene or polyethylene homopolymer and copolymer compositions. In some embodiments, those other polyethylene polymers are selected from the group consisting of LLDPE, HDPE, MDPE, LDPE, and other differentiated polyethylenes.

In some embodiments, the formulated blends can contain additives, which are determined based upon the end use of the formulated blend. In some embodiments, the additives are selected from the group consisting of fillers, antioxidants, phosphites, anti-cling additives, tackifiers, ultraviolet stabilizers, heat stabilizers, antiblocking agents, release agents, antistatic agents, pigments, colorants, dyes, waxes, silica, processing aids, neutralizers, lubricants, surfactants, and nucleating agents. In some embodiments, additives are present in an amount from 0.1 ppm to 5.0 wt %.

Polyethylene copolymers of the present disclosure can be optionally blended with one or more processing aids to form a polyethylene blend. Because of the improved properties of polyethylene copolymers of the present disclosure, advantageously, such processing aids can be omitted even in blown films (for example, films, and particularly blown films, of some embodiments may be free of or substantially free of polymer processing aids, and especially polymer processing aids comprising fluorine; where “substantially free” means free of any intentionally added components, but allowing for up to 100 ppm of such component(s) as impurities).

### Polymerization Processes

The polymerization process can include a gas phase polymerization reaction, and in particular a fluidized bed gas phase polymerization reaction. The gas-phase polymerization may be carried out in any suitable reactor system, for example, a stirred- or paddle-type reactor system. See U.S. Pat. Nos. 7,915,357; 8, 129,484; 7,202,313; 6,833,417; 6,841,630; 6,989,344; 7,504,463; 7,563,851; 8,101,691; and 9,718,896 for discussion of suitable gas phase fluidized bed polymerization systems, which are well known in the art. Each of these references are incorporated herein by reference in their entireties.

In such polymerization processes, a gas-phase, fluidized-bed process is conducted by passing a stream containing ethylene and an olefin comonomer continuously through a fluidized-bed reactor under reaction conditions and in the presence of a catalyst composition at a velocity sufficient to maintain a bed of solid particles in a suspended state. A stream (which may be called a “cycle gas” stream) containing unreacted ethylene and olefin comonomer is continuously withdrawn from the reactor, compressed, cooled, optionally partially or fully condensed, and recycled back to the reactor. Prepared polyethylene copolymer is withdrawn from the reactor and replacement ethylene and olefin comonomer are added to the recycle stream. In some embodiments, gas inert to the catalyst composition and reactants is present in the gas stream.

The cycle gas can include induced condensing agents (ICA). An ICA is one or more non-reactive alkanes that are condensable in the polymerization process for removing the heat of reaction. In some embodiments, the non-reactive alkanes are selected from C₁-C₆ alkanes, for example, one or more of propane, butane, isobutane, pentane, isopentane, hexane, as well as isomers thereof and derivatives thereof. In some instances, mixtures of two or more such ICAs may be particularly desirable (for example, propane and pentane, propane and butane, butane and pentane, etc.).

A variety of gas phase polymerization processes may be used. For example, polymerization may be conducted in “dry” mode (or uncondensed mode), in “condensed” mode, or in “super-condensed” mode.

In “dry” mode (typical ICA concentration is less than 10 mol % with respect to total cycle gas), the ICA is injected into the reactor along with other components of the cycle gas in gaseous form. In “condensed” or “super condensed mode”, the ICA (typical ICA concentration could be as high as 30-35% with respect to total cycle gas) are in a liquid form mixed with other components of the cycle gas. In some embodiments, the gas phase process is substantially free of ICA. It may be desired to maximize ICA concentration for faster commercial runtimes; however, reducing ICA may have beneficial effects on comonomer distribution.

The reactor pressure may vary from 100 psig (680 kPag) to 500 psig (3448 kPag), or from 200 psig (1379 kPag) to 400 psig (2759 kPag), or from 250 psig (1724 kPag) to 350 psig (2414 kPag). In some embodiments, the reactor is operated at a temperature in the range of 60° C. to 120° C., 60° C. to 115° C., 70° C. to 110° C., 70° C. to 95° C., or 80° C. to 90° C. A ratio of hydrogen gas to ethylene can be 10 to 30 ppm/mol %, such as 15 to 25 ppm/mol %, such as 16 to 20 ppm/mol %.

The mole percent of ethylene may be from 25.0-90.0 mole percent, or 50.0-90.0 mole percent, or 70.0-85.0 mole percent, and the ethylene partial pressure is in the range of from 75 psia (517 kPa) to 300 psia (2,069 kPa), or from 100 to 275 psia (from 689 to 1,894 kPa), or from 150 to 265 psia (from 1,034 to 1,826 kPa), or from 180 to 200 psia (1,241 to 1,379 kPa).

Ethylene concentration in the reactor can also range from 35 to 95 mol %, such as within the range from a low of 35, 40, 45, 50, or 55 mol % to a high of 70, 75, 80, 85, 90, or 95 mol % and further where ethylene mol % is measured on the basis of total moles of gas in the reactor (including, if present, ethylene and/or comonomer gases as well as inert gases such as one or more of nitrogen, isopentane or other ICA(s), etc.); as with vol-ppm hydrogen, this measurement may for convenience be taken in the cycle gas outlet rather than in the reactor itself. Comonomer concentration can range from 0.2 to 1.0 mol %, such as within the range from a low of 0.2, 0.3, 0.4 or 0.5 mol % to a high of 0.65, 0.70, 0.75, 0.80, 0.85, 0.90, 0.95, or 1.0 mol %.

### Catalysts

The catalysts employed in the polymerization can be metallocene catalysts. In particular, metallocene catalysts may be selected from the catalysts described in Patent Cooperation Treaty Publication Nos. WO1993008221, WO1996008520, WO1998044011, and WO2007130277, incorporated herein by reference for all purposes. For instance, the catalysts may be silica-supported metallocene catalyst prepared from compositions comprising dimethylsilylbis(tetrahydroindenyl) zirconium dichloride metallocene and methylalumoxane cocatalyst. In some embodiments, a catalyst is dimethylsilylbis(tetrahydroindenyl) zirconium dichloride.

### Articles of Manufacture

Embodiments of the present disclosure also generally relate to articles. The polyethylene copolymers of the present disclosure can be particularly suitable for making end-use articles of manufacture such as films (for example, as may be formed by lamination, extrusion, coextrusion, casting, and/or blowing); as well as other articles of manufacture as may be formed, for example, by rotomolding or injection molding. Other articles that can be made from polyethylene copolymers of the present disclosure can include, but are not limited to, lamitubes, hygiene products, waterproof sheets (such as pre-applied waterproofing sheets), and pipe adhesives.

Illustrative, but non-limiting, examples of hygiene products that can be made using polyethylene copolymer(s) described herein include blown breathable films.

Polyethylene copolymers can be formed into articles of manufacture by any suitable process, such as cast film extrusion, blown film extrusion, rotational molding, injection molding processes, or other suitable processes. In some embodiments, the polyethylene copolymer can be used in a blend.

Polyethylene copolymers of the present disclosure can provide excellent shear thinning characteristics with little or no melt fracture of the extrudate at high die shear rates. For example, polyethylene copolymers of the present disclosure (for example, having an MI of about 1 to about 2.5 g/10 min and a density of about 0.930 to 0.945 g/cm³) can be used as skin layers in blown films to provide melt fracture free films, which allows polymer processing aids (such as per- or poly-fluoro alkanes) to be merely optional (or, preferably, eliminated entirely from such blown film formulations, such that the films are free or substantially free of polymer processing aids such as fluorine-containing polymer processing aids). Further, polyethylene copolymers of the present disclosure (for example, having an MI of about 1 to about 2.5 g/10 min and a density of about 0.930 to 0.945 g/cm³) can provide films formed with reduced motor load and melt pressure (which increases input) due to improved flow behavior, as compared to conventional LLDPEs, conventional MDPEs, and other conventional polyethylene copolymers.

In some embodiments, a lamitube includes a polyethylene copolymer of the present disclosure. In at least one embodiment, a polyethylene copolymer suitable for use in a lamitube can have one or more of the following properties: a complex shear viscosity (η*) @ 0.01 rad/sec and 190° C. of 15,000 Pa·s to 25,000 Pa·s; a complex shear viscosity (η*) @ 100 rad/sec and 190° C. of 1,100 Pa·s to 1,300 Pa·s; a density of 0.935 g/cm³ to 0.942 g/cm³; and a melt index of 1 g/10 min to 1.5 g/10 min. Other properties for the polyethylene copolymer suitable for use in a lamitube are contemplated.

In some embodiments, a pre-applied waterproofing sheet includes a polyethylene copolymer of the present disclosure. In at least one embodiment, a polyethylene copolymer suitable for use in a pre-applied waterproofing sheet can have one or more of the following properties: a density of 0.935 g/cm³ to 0.945 g/cm³ and a melt index of 1.0 g/10 min to 1.5 g/10 min. Other properties for the polyethylene copolymer suitable for use in a pre-applied waterproofing sheet are contemplated.

In some embodiments, a hygiene product can include a polyethylene copolymer of the present disclosure. In at least one embodiment, a polyethylene copolymer suitable for use in a hygiene product can have one or more of the following properties: a complex shear viscosity (η*) @ 0.01 rad/sec and 190° C. of 8,000 Pa·s to 10,000 Pa·s; a complex shear viscosity (η*) @ 100 rad/sec and 190° C. of 900 Pa·s to 1,100 Pa·s; a density of 0.935 g/cm³ to 0.940 g/cm³; and a melt index of 1.5 g/10 min to 2.5 g/10 min. Other properties for the polyethylene copolymer suitable for use in a hygiene product are contemplated.

In some embodiments, a polyethylene copolymer or blend thereof provides a smooth extrudate at an apparent die (wall) shear rate between 80-150 s⁻¹ without significant melt fracture by visual observation (again, even without PPA such as fluorine-containing PPA).

A polyethylene copolymer (or blend thereof) of the present disclosure can be useful in such forming operations as film, sheet, and fiber extrusion and co-extrusion as well as blow molding, injection molding, and rotary molding. Films include blown or cast films formed by, for example, co-extrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications. Fibers can include melt spinning, solution spinning and melt blown fiber operations for use in woven or non-woven form to make filters, diaper fabrics, medical garments, geotextiles, among others. Extruded articles can include medical tubing, wire and cable coatings, pipe, geomembranes, and pond liners, among others. Molded articles can include single and multi-layered constructions in the form of bottles, tanks, large hollow articles, rigid food containers and toys, among others.

The polyethylene copolymers (or blends thereof) may be formed into monolayer films or multilayer films. These monolayer films and/or multilayer films may be formed by any suitable technique including, for example, extrusion, co-extrusion, extrusion coating, lamination, blowing, and casting, among other suitable techniques. The film may be obtained by the flat film or tubular process which may be followed by orientation in a uniaxial direction or in two mutually perpendicular directions in the plane of the film.

One or more of the layers of the film may be oriented in the transverse direction and/or longitudinal direction to the same or different extents. This orientation may occur before and/or after the individual layers are brought together. For example, a polyethylene copolymer (or a blend thereof) layer can be extrusion coated or laminated onto an oriented polypropylene layer or the polyethylene copolymer (or blend thereof) and polypropylene can be co-extruded together into a film and then oriented. Likewise, oriented polypropylene could be laminated to oriented polyethylene copolymer (or blend thereof), or oriented polyethylene copolymer (or blend thereof) could be coated onto polypropylene then optionally the combination could be oriented even further if desired.

Films include monolayer films or multilayer films. Specific end use films include, for example, blown films, cast films, stretch films, stretch/cast films, stretch cling films, stretch handwrap films, machine stretch wrap, shrink films, shrink wrap films, greenhouse films, laminates, and laminate films. Exemplary films can be prepared by any conventional technique known to those skilled in the art, such as for example, techniques utilized to prepare blown, extruded, and/or cast stretch and/or shrink films (including, for example, shrink-on-shrink applications).

In one embodiment, multilayer films (multiple-layer films) may be formed by any suitable method. The total thickness of multilayer films may vary based upon the application desired. A total film thickness of 5 μm to 100 μm, such as 10 μm to 50 μm, can be suitable for most applications. Those skilled in the art will appreciate that the thickness of individual layers for multilayer films may be adjusted based on desired end-use performance, polymer(s) employed, equipment capability, and other factors.

The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment the multilayer films are composed of five to ten layers.

Embodiments of the present disclosure can be further understood by the following non-limiting examples. The following examples are put forth so as to provide those of ordinary skill in the art with a complete disclosure and description of how to make and use aspects of the present disclosure, and are not intended to limit the scope of aspects of the present disclosure.

### EXAMPLES

Polyethylene copolymers, according to one or more embodiments provided herein, were produced in a continuous gas phase fluidized bed polymerization reactor. Polyethylene copolymers according to embodiments described herein are referred to as example (Ex.) resins.

Example resins 1-6 were produced at pilot plant scale under “dry” mode. Example resins 1 and 2 are samples with similar targeted specifications (density of about 0.937 g/cm³; and MI of about 1 g/10 min). Similarly, example resins 3 and 4 (density of about 0.937 g/cm³; and MI of about 1.5 g/10 min) as well as example resins 5 and 6 (density of about 0.937 g/cm³; and MI of about 2 g/10 min) represent pairs of samples with the same targeted specifications.

Table 1 shows non-limiting polymerization conditions used to form example resins 1-6. The polymerization was conducted in a continuous gas phase fluidized bed reactor. The fluidized bed was made up of catalyst and growing polymer granules. The gaseous feed streams of ethylene and hydrogen together with liquid comonomer were mixed together in a mixing tee arrangement and introduced below the reactor bed into the recycle gas line. An ICA (isopentane) was added with the ethylene and hydrogen and also introduced below the reactor bed into the recycle gas line. The individual flow rates of ethylene, hydrogen, and comonomer were controlled to maintain fixed composition targets. The ethylene concentration was controlled to maintain a constant ethylene partial pressure. The hydrogen was controlled to maintain a constant hydrogen to ethylene mole ratio. The concentration of each gas was measured by an on-line gas chromatograph to ensure a relatively constant composition in the recycle gas stream.

TABLE 1

| | Ex. 1 | Ex. 2 | Ex. 3 | Ex. 4 | Ex. 5 | Ex. 6 |
|---|---|---|---|---|---|---|
| Residence time, h | 4.9 | 4.9 | 5.3 | 5.3 | 5.7 | 5.7 |
| Production rate, lbs/h | 144 | 144 | 138 | 138 | 141 | 141 |
| Reactor Bed Temp (Median), ° F. | 195 | 195 | 195 | 195 | 195 | 195 |
| Ethylene partial pressure, psia | 198 | 198 | 198 | 198 | 198 | 198 |
| Hydrogen gas ratio | 9.6 | 9.6 | 10.9 | 10.9 | 11.6 | 11.6 |
| H₂/C₂, ppm/mol % | | | | | | |
| Comonomer gas ratio C6/C2, | 0.0036 | 0.0036 | 0.0038 | 0.0038 | 0.0040 | 0.0040 |
| mol/mol | | | | | | |
| Isopentane concentration, mol % | 10 | 10 | 10 | 10 | 10 | 10 |

Example resins 1-6 were compared to conventional resins. The conventional resins, which are referred to as comparative (C.Ex.) resins, included Enable™ 3505MC (C.Ex. 1), Enable™ 4009MC (C.Ex. 2), and Dowlex™ 2036P (C.Ex. 3). Comparative resins 1 and 2 were produced via “condensed” mode. Enable™ 3505MC and Enable™ 4009MC resins are ethylene 1-hexene copolymers available from ExxonMobil Chemical Company of Houston, TX. Dowlex™ 2036P is an LLDPE available from the Dow Chemical Company. Table 2 shows selected, and non-limiting, properties of the example resins and the comparative resins.

TABLE 2

| | | | | | | | | | |
|---|---|---|---|---|---|---|---|---|---|
| Sample ID | Ex. 1 | Ex. 2 | Ex. 3 | Ex. 4 | Ex. 5 | Ex. 6 | C. Ex. 1 | C. Ex. 2 | C. Ex. 3 |

MI and Density

| | | | | | | | | | |
|---|---|---|---|---|---|---|---|---|---|
| MI, g/10 min | 1.09 | 1.02 | 1.61 | 1.53 | 2.08 | 2.06 | 0.43 | 0.90 | 2.52 |
| HLMI, g/10 min | 47.6 | 44.8 | 63.3 | 59.9 | 77.1 | 76.8 | 24.1 | 36.9 | 60.7 |
| MIR | 43.9 | 43.8 | 39.4 | 39.2 | 37.1 | 37.2 | 55.9 | 40.8 | 24.1 |
| Density, | 0.937 | 0.937 | 0.937 | 0.935 | 0.936 | 0.936 | 0.935 | 0.938 | 0.935 |
| g/cm³ | | | | | | | | | |

GPC 4D

| | | | | | | | | | |
|---|---|---|---|---|---|---|---|---|---|
| M_{w}, g/mol | 84713 | 85790 | 79077 | 79626 | 74071 | 74955 | 101872 | 88240 | 90782 |
| Mₙ, g/mol | 19911 | 20013 | 18255 | 18558 | 17887 | 18058 | 26032 | 20910 | 26189 |
| MWD | 4.25 | 4.29 | 4.33 | 4.29 | 4.14 | 4.15 | 3.91 | 4.22 | 3.47 |
| M_{z}, g/mol | 197999 | 200452 | 183405 | 182403 | 169517 | 169778 | 232317 | 198242 | 276979 |
| M_{z+1} | 326893 | 332317 | 302886 | 299377 | 280703 | 277589 | 379441 | 322311 | 744385 |
| C₆, wt % | 2.91 | 3.03 | 3.17 | 3.48 | 3.4 | 3.51 | 2.81 | 2.56 | 3.26 |
| LCB, g′ | 0.975 | 0.98 | 0.974 | 0.969 | 0.971 | 0.983 | 0.982 | 0.987 | 0.985 |

SAOS

| | | | | | | | | | |
|---|---|---|---|---|---|---|---|---|---|
| η_{0.01}, Pa · s | 21609 | 24603 | 12723 | 13042 | 8569 | 8564 | 76266 | 19250 | 3726 |
| η₁₀₀, Pa · s | 1251 | 1310 | 1090 | 1117 | 985 | 990 | 1844 | 1633 | 1230 |
| η_{0.01}/η₁₀₀ | 17.27 | 18.78 | 11.68 | 11.68 | 8.70 | 8.65 | 41.35 | 11.79 | 3.03 |

¹H NMR

| | | | | | | | | | |
|---|---|---|---|---|---|---|---|---|---|
| Vinylenes/ | 0.08 | 0.09 | 0.09 | 0.09 | 0.07 | 0.08 | 0.07 | 0.06 | 0.03 |
| 1000 C | | | | | | | | | |
| Trisubstituted | 0.09 | 0.09 | 0.1 | 0.12 | 0.09 | 0.12 | 0.07 | 0.05 | 0.04 |
| olefins/1000 C | | | | | | | | | |
| Vinyls/1000 C | 0.01 | 0.02 | 0.02 | 0.02 | 0.01 | 0.02 | 0.02 | 0.02 | 0.21 |
| Vinylidenes/ | 0 | 0 | 0 | 0 | 0 | 0 | 0 | 0 | 0 |
| 1000 C | | | | | | | | | |
| Total | 0.18 | 0.2 | 0.21 | 0.23 | 0.17 | 0.22 | 0.16 | 0.13 | 0.28 |
| Unsaturation | | | | | | | | | |

¹³C NMR

| | | | | | | | | | |
|---|---|---|---|---|---|---|---|---|---|
| EEE, mol % | 97.4 | 97.3 | 97.3 | 97.2 | 96.9 | 97.0 | 97.3 | 97.9 | 96.9 |
| HEE, mol % | 1.7 | 1.8 | 1.8 | 2.0 | 2.1 | 2.0 | 1.7 | 1.4 | 2.8 |
| HEH, mol % | 0.0 | 0.0 | 0.0 | 0.0 | 0.0 | 0.0 | 0.0 | 0.0 | 0.0 |
| EHE, mol % | 0.8 | 0.8 | 0.8 | 0.9 | 1 | 0.9 | 0.9 | 0.7 | 0.8 |
| EHH, mol % | 0.0 | 0.0 | 0.0 | 0.0 | 0.0 | 0.0 | 0.0 | 0.0 | 0.0 |
| HHH, mol % | 0.0 | 0.0 | 0.1 | 0.1 | 0.0 | 0.1 | 0.1 | 0.1 | 0.0 |
| C₂, mol % | 99.2 | 99.1 | 99.1 | 99.1 | 99.0 | 99.1 | 99.1 | 99.3 | 99.8 |
| C₆, mol % | 0.8 | 0.9 | 0.9 | 0.9 | 1.0 | 0.9 | 0.9 | 0.7 | 0.2 |
| C₂, wt % | 97.5 | 97.4 | 97.4 | 97.3 | 96.9 | 97.2 | 97.3 | 97.9 | 99.3 |
| C₆, wt % | 2.5 | 2.6 | 2.6 | 2.7 | 3.1 | 2.8 | 2.7 | 2.1 | 0.7 |
| Branching/ | 4.1 | 4.3 | 4.3 | 4.5 | 5.2 | 4.7 | 4.6 | 3.5 | 2.0 |
| 1000 C | | | | | | | | | |

TREF

| | | | | | | | | | |
|---|---|---|---|---|---|---|---|---|---|
| T₇₅ − T₂₅, ° C. | 2.5 | 2.6 | 2.8 | 3 | 3.2 | 3.1 | 2 | 2 | 8.9 |

Parameter

| | | | | | | | | | |
|---|---|---|---|---|---|---|---|---|---|
| α parameter | 446 | 498 | 298 | 320 | 249 | 241 | 1183 | 228 | 187 |
| β parameter | 262 | 302 | 193 | 224 | 193 | 180 | 605 | 108 | 480 |

The non-limiting ¹H NMR data illustrated in Table 2 reveals that the example resins have higher levels of trisubstituted olefins/1000 C than the comparative resins. For example, example resins 1-6 had from about 0.09 to about 0.12 trisubstituted olefins/1000 C, while comparative resins 1-3 had about 0.07 trisubstituted olefins/1000 C or less. Such a higher level of trisubstituted olefins/1000 C shown by the example resins can indicate the presence of hindered double bonds.

In addition, the example resins have higher levels of total unsaturation than Enable™ 3505MC and Enable™ 4009MC. For example, the example resins had a total unsaturation ranging from about 0.17 to 0.23, versus 0.16 and 0.13 for Enable™ 3505MC and Enable™ 4009MC, respectively. The higher level of total unsaturation for the example resins is surprising because the example resins have a much higher MI. Here, since the higher MI resins (2 g/10 min versus 1.5 g/10 min versus 1 g/10 min) produced with the same catalyst have a higher hydrogen/ethylene ratio in the reactor, there may be a greater potential for lowering the unsaturation.

The non-limiting ¹³C NMR data shows that most of the hexenes in the example resins are isolated hexenes as shown by the triad content. For example, [HHH] triad content was found to be about 0.001 mol % or less for the example resins, while [EEE] triad content ranged from about 0.969 mol % to about 0.974 mol %. The [HEE] triad content of the example resins—from about 0.017 mol % to about 0.021 mol %—was superior to comparative resin 1 (0.017 mol %) and comparative resin 2 (0.014 mol %). The example resins also displayed good levels of C₆/C₂ content relative to the comparative resins, with Dowlex™ 2036P having a very low C₆ content. Further, the values for branching/1000 C follows the C₆/C₂ content.

The co-monomer distribution in the various resins was determined on the basis of TREF results. The example resins showed a narrow distribution reflected by the relatively small difference in the T₇₅−T₂₅ value. Here, the T₇₅−T₂₅ value for the example resins was found to be from about 2.5° C. to about 3.2° C., versus 2° C. (comparative resins 1 and 2) and 8.9° C. (comparative resin 3). These results may indicate that the composition distribution of the example resins are linked to the ICA concentration.

Melt index (MI) and density data is also shown in Table 2. Here, the MI of example resins 1-6 were found to be much higher than comparative resins 1 and 2 and lower than comparative resin 3. Specifically, the MI of the example resins were determined to be about 1 g/10 min for example resins 1 and 2 (˜1.09 and ˜1.02, respectively), about 1.5 g/10 min for example resins 3 and 4 (˜1.61 and ˜1.53, respectively), and about 2 g/10 min for example resins 5 and 6 (˜2.08 and ˜2.06, respectively), while comparative resins 1 and 2 had a MI of 0.43 g/10 min and 0.9 g/10 min, respectively, and comparative resin 3 had a MI of 2.52 g/10 min. These results indicate that example resins 1-6 have a lower melt viscosity than comparative resins 1 and 2, and hence easier extrudability, while comparative resin 3 has a lower melt viscosity (and is more easily extruded) than example resins 1-6. However, comparative resin 3 has a lower zero shear viscosity (see FIG. 2) than example resins 1-6 which leads to lower bubble stability during film blowing.

Further, the high load melt index (HLMI) of example resins 1-6 were determined to be much higher than the comparative resins 1 and 2, and example resins 3, 5, and 6 had a higher HLMI than comparative resin 3. The HLMI results are similar to the melt index results (melt viscosity and extrudability), but at a slightly higher shear rate. The MIR of the example resins was determined to be from about 37.1 to about 43.9.

The densities of the example resins ranged from about 0.935 g/cm³ to about 0.937 g/cm³ indicating that the example resins are relatively higher density linear polyethylene (which are sometimes referred to as medium density polyethylene). The densities indicate that the example resins described herein can be used in a variety of applications such as, for example, lamitubes, hygiene products, blown breathable films, waterproof sheets, and pipe adhesives, among others.

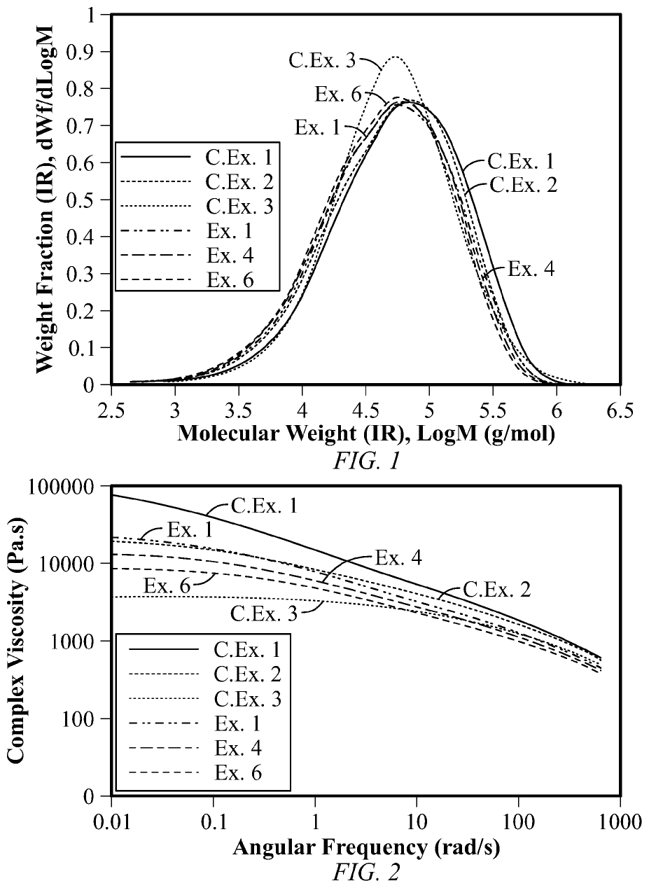

Table 2 also shows selected molecular weight and comonomer content data generated using GPC 4D. The overall molecular weight distribution data (IR) for example resins 1, 4, and 6, and comparative resins 1-3 are plotted in FIG. 1. For clarity, data for only one resin from each pair of example resins is included in FIG. 1. For example resins 1-6, the average molecular weights follow the observed MI trend, where high MI (˜2 g/10 min) example resins have a lower average molecular weight compared to the lower MI (˜1 g/10 min) resins. For example resins 1-6 and comparative resins 1 and 2, the GPC data indicates that a lower molecular weight can lead to easier extrudability but less bubble stability, while a higher molecular weight can lead to greater bubble stability but less easier extrudability.

In addition, the presence of a small amount of long chain branches (LCB) in commercial ENABLE™ grades can improve processability in cast film application. The presence of LCB can generally provide processing advantages such as reduced neck-in and increased draw stability. It was discovered that example resins of the present disclosure can maintain such advantageous LCB, even while achieving the higher density and MI. In addition, the properties of the example resins, relative to those of comparative commercial grades can lead to lower head pressures and temperatures during extrusion while maintaining bubble stability, which can lead to increased output.

Viscosity flow data using SAOS data are shown in FIG. 2. Viscosities at approximately 100 rad/s (η₁₀₀) and 0.01 rad/s (η_{0.01}) for the example and comparative resins are shown in Table 2. Shear rates close to a range of about 100 to 1000 rad/s are typically encountered during the extrusion phase of film fabrication. The example resins have much lower η₁₀₀ values (about 1310 Pa·s or less) than comparative resins 1 and 2 (1844 Pa·s and 1633 Pa·s, respectively). The lower η₁₀₀ values of the example resins would lead to lower melt pressures and thus higher extrusion rates during melt processing relative to comparative resins 1 and 2. The η₁₀₀ value of comparative resin 3 is similar to example resins 1 and 2 (but higher than example resins 3-6). However, comparative resin 3 also has a very low η_{0.01} value compared to the example resins, which leads to poor bubble stability during blown film fabrication when using resins with a η_{0.01} value like that of comparative resin 3.

FIG. 3 shows Van Gurp Palmen curves for example resins and comparative resins according to at least one embodiment of the present disclosure. All of example resins 1-6 show an inflection point in their Van Gurp Palmen curve, indicating the presence of long chain branching. Comparative resin 3 illustrates an LLDPE without any long chain branching. Thus, polyethylene copolymers of the present disclosure can be characterized as having an inflection point in a Van Gurp Palmen curve.

Polyethylene polymers and articles made therefrom are described herein. Overall, embodiments of the MDPE polymers and articles made therefrom provide numerous advantages. The MDPE polymers described herein can be copolymers having a combination of high density, high melt index, maintained long chain branching, while also providing commercially desirable processing characteristics and extrusions of the MDPE polymers.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

All priority documents are herein fully incorporated by reference for all purposes and for all jurisdictions in which such incorporation is permitted and to the extent such description is consistent with the present disclosure. Further, all documents and references cited herein, including testing procedures, publications, patents, journal articles, etc. are herein fully incorporated by reference for all jurisdictions in which such incorporation is permitted and to the extent such description is consistent with the disclosure.

Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the claimed invention, additionally, the phrases do not exclude impurities and variances normally associated with the elements and materials used.

While the foregoing is described with respect to a number of embodiments and examples, those skilled in the art, having benefit of this disclosure, will appreciate that other embodiments can be devised which do not depart from the scope and spirit of the disclosure.

What is claimed is:

1. A polyethylene copolymer, comprising:
ethylene units; and
1 wt % to 8 wt % of C₃-C₈ alpha-olefin comonomer units, the polyethylene copolymer having:
a density of 0.934 g/cm³ to 0.945 g/cm³;
a melt index (MI, determined per ASTM D1238 at 190° C. and 2.16 kg loading) greater than 0.9 g/10 min and less than or equal to 2.5 g/10 min;
a composition distribution breadth index of 75% or greater;
a molecular weight distribution (MWD, M_{w}/Mₙ) of 2 to 8; and
a melt index ratio (MIR) within the range from 30 to 75, wherein MIR is the ratio of high load melt index (HLMI, ASTM D1238 at 190° C., 21.6 kg) to melt index (MI, ASTM D1238 at 190° C., 2.16 kg).

2. The polyethylene copolymer of claim 1, having long chain branching.

3. The polyethylene copolymer of one of claim 1, having an inflection point in a Van Gurp Palmen plot of phase angle vs. complex modulus (Pa) of the polyethylene copolymer.

4. The polyethylene copolymer of claim 1, wherein the polyethylene copolymer has an α parameter of 230 to 1,000, as determined by Eq. 1:
α parameter=(MIR*η_{0.01}/η₁₀₀)*(T₇₅−T₂₅)/MWD (Eq. 1)
wherein MIR is melt index ratio, η_{0.01} is complex shear viscosity (η*) @ 0.01 rad/sec and 190° C., η₁₀₀ is complex shear viscosity (η*) @ 100 rad/sec and 190° C., T₇₅−T₂₅ is T₇₅−T₂₅ value, wherein T₂₅ is the temperature at which 25% of eluted polyethylene copolymer is obtained and T₇₅ is the temperature at which 75% of eluted polyethylene copolymer is obtained using temperature rising elution fractionation, and MWD is molecular weight distribution.

5. The polyethylene copolymer of claim 1, wherein the polyethylene copolymer has 0.09 to 0.12 trisubstituted vinylenes/1000 carbon atoms.

6. The polyethylene copolymer of claim 1, wherein the polyethylene copolymer has one or more of the following properties:
An [EEE] triad content of 95 mol % to 99 mol %;
an [HEE] triad content of 1.4 mol % to 2.2 mol %;
an [EHE] triad content of 0.7 mol % to 1 mol %;
an [HHH] triad content of 0.1 mol % or less;
an [HEH] triad content of 0.05 mol % or less; or
an [EHH] triad content of 0.05 mol % or less.

7. The polyethylene copolymer of claim 1, wherein the polyethylene copolymer has a density of 0.935 g/cm³ to 0.938 g/cm³.

8. The polyethylene copolymer of claim 1, wherein the polyethylene copolymer has a density of 0.937 g/cm³ to 0.94 g/cm³.

9. The polyethylene copolymer of claim 1, wherein:
the C₃-C₈ alpha-olefin comonomer units are 1-hexene units; and
the polyethylene copolymer comprises 92 wt % to 99 wt % ethylene.

10. The polyethylene copolymer of claim 1, wherein the polyethylene copolymer further has:
a MI of 0.9 g/10 min to 2 g/10 min;
a T₇₅−T₂₅ value of 2° C. to 10° C.;
a melt index ratio (MIR, HLMI/MI) of 35 to 45; or
combinations thereof.

11. The polyethylene copolymer of claim 1, wherein the polyethylene copolymer further has one or more of the following properties:
(a) a MI of 1 g/10 min to 2 g/10 min;
(b) a T₇₅−T₂₅ value of 1.5° C. to 4° C.;
(c) a high load melt index (HLMI, determined per ASTM D1238 at 190° C. and 21.6 kg loading) of 35 g/10 min to 80 g/10 min;
(d) a melt index ratio (MIR, HLMI/MI) of 37 to 44;
(e) a weight-average molecular weight (Mw) of 70,000 g/mol to 90,000 g/mol; or
(f) a number-average molecular weight (Mn) of 15,000 g/mol to 30,000 g/mol.

12. The polyethylene copolymer of claim 11, having all of the properties (a)-(f).

13. The polyethylene copolymer of claim 1, wherein the polyethylene copolymer has an HLMI of 40 g/10 min to 50 g/10 min.

14. The polyethylene copolymer of claim 1, wherein the polyethylene copolymer has an HLMI of 65 g/10 min to 80 g/10 min.

15. The polyethylene copolymer of claim 1, wherein the polyethylene copolymer has:
a complex shear viscosity (η*) @ 0.01 rad/sec and 190° C. of 8,000 Pa·s to 25,000 Pa·s; and
a complex shear viscosity (η*) @ 100 rad/sec and 190° C. of 900 Pa·s to 1,500 Pa·s.

16. An article, comprising a polyethylene copolymer of claim 1.

17. The article of claim 16, wherein:
the article is a cast film or a blown film; and
the polyethylene copolymer has:
a density of 0.935 g/cm³ to 0.938 g/cm³; and
a melt index of 1.1 g/10 min to 1.3 g/10 min.

18. The article of claim 16, wherein:
the article is a cast film or a blown film; and
the polyethylene copolymer has:
a density of 0.935 g/cm³ to 0.938 g/cm³; and
a melt index of 1.8 g/10 min to 2.0 g/10 min.

19. The article of one of claim 17, wherein the blown film is substantially free of a per-fluoro alkane or a poly-fluoro alkane.

20. The article of claim 16, wherein:
the article is a lamitube; and
the polyethylene copolymer has:
a complex shear viscosity (η*) @ 0.01 rad/sec and 190° C. of 15,000 Pa·s to 25,000 Pa·s;
a complex shear viscosity (η*) @ 100 rad/sec and 190° C. of 1,100 Pa·s to 1,300 Pa·s;
a density of 0.935 g/cm³ to 0.942 g/cm³; and
a melt index of 1 g/10 min to 1.5 g/10 min.

21. The article of claim 16, wherein:
the article is a hygiene product; and
the polyethylene copolymer has:
a complex shear viscosity (η*) @ 0.01 rad/sec and 190° C. of 8,000 Pa·s to 10,000 Pa·s;
a complex shear viscosity (η*) @ 100 rad/sec and 190° C. of 900 Pa·s to 1,100 Pa·s;
a density of 0.935 g/cm³ to 0.940 g/cm³; and
a melt index of 1.5 g/10 min to 2.5 g/10 min.

22. The article of claim 16, wherein:
the article is a pre-applied waterproofing sheet; and
the polyethylene copolymer has:
a density of 0.935 g/cm³ to 0.945 g/cm³; and
a melt index of 1.0 g/10 min to 1.5 g/10 min.
